(19) United States
(12) Patent Application Publication
(10) Pub. No.: US 2025/0074464 A1
(43) Pub. Date: Mar. 6, 2025

(54) ASSISTANCE SYSTEM FOR USE ON THE ROAD SURFACE

(71) Applicant: Intel Corporation, Santa Clara, CA (US)

(72) Inventors: Fabian OBORIL, Karlsruhe (DE); Cornelius BUERKLE, Karlsruhe (DE); Frederik PASCH, Karlsruhe (DE)

(21) Appl. No.: 18/791,444

(22) Filed: Aug. 1, 2024

(30) Foreign Application Priority Data
Sep. 4, 2023 (DE) 10 2023 123 719.5

(51) Int. Cl. B60W 60/00; B60K 35/22; B60K 35/28

(52) U.S. Cl. CPC B60W 60/0013; B60K 35/22; B60K 35/28; B60W 2510/22; B60W 2520/105; B60W 2540/00; B60W 2552/35; B60W 2556/45; B60W 2710/22; B60W 2720/10

(57) ABSTRACT

A driving assistance device comprises a processor which is configured to generate a risk map using road surface data and vehicle data; and to generate a driving instruction based on the risk map; wherein the risk map represents areas of risk related to a road surface within a vicinity of a vehicle; and wherein the road surface data represent irregularities of a road surface within the vicinity of the vehicle.

### CROSS-REFERENCE TO RELATED APPLICATIONS

This application claims priority to DE Application 10 2023 123 719.5, filed on Sep. 4, 2023, the entire contents of which are incorporated herein by reference.

### TECHNICAL FIELD

Various aspects of this disclosure generally relate to the detection of irregularities of a road surface using sensor data, the assessment of the risk associated with these detected irregularities, and the generation of instructions on the basis of the assessed risk.

### BACKGROUND

The quality of a road surface or a navigable unpaved surface (e.g. off-road) varies greatly, e.g. from country to country, between rural and urban areas, and between different types of road (e.g. asphalt, gravel roads, unpaved country roads, etc.). Although most major roads in Europe have very smooth and regular surfaces that are free of potholes or irregularities, there are still many minor roads, such as gravel roads, which have a poor or uneven surface. When considering road quality worldwide, poor surface quality is the rule rather than the exception.

Although many advanced driving assistance systems (ADAS) can improve comfortability and safety in road traffic (e.g., emergency braking assistant or adaptive cruise control), these systems do not analyze the entire road surface in front of the vehicle (e.g., the road surface over which the vehicle will travel) to give the driver instructions with regard to, for example, the route, driving, speed or suspension adjustments.

Different systems can extract the composition of the road surface (navigable area) from sensor data. Other systems can detect road sleepers (e.g. speed bumps) based on sensor data. Such results can be shared, for example, via wireless communication (e.g., vehicle-to-vehicle communication (V2V) or via a cloud-based system). Such systems, however, only deal with individual (isolated) findings (e.g. a single road hump, a single uneven area). Such systems cannot provide meaningful driving instructions for operation on a gravel road consisting essentially of uneven or bumpy areas, or for operation on a road with numerous humps and/or potholes. Such roads require additional system components that can be used to convert detected irregularities and potholes into useful driving instructions. Such an analysis could significantly increase road safety, as drivers or automatic assistance systems would receive instructions to avoid potholes or to reduce speed, thereby reducing the risk of punctures, mechanical failures, or loss of control of the vehicle.

### BRIEF DESCRIPTION OF THE DRAWINGS

In the drawings, the same reference signs in the different views generally refer to the same parts throughout. The drawings are not necessarily true to scale, but are generally focused on illustrating the exemplary principles of the disclosure. The following description describes various embodiments of the invention with reference to the following drawings, in which:

FIG. 1 shows elements of the driving assistance device;

FIG. 2 shows an alternative implementation of the driving assistance device;

FIG. 3 shows detailed versions of elements 112 to 122 as illustrated in FIG. 1;

FIG. 4 shows a device for detecting irregularities of a road surface based on the tracking of vehicle behavior;

FIG. 5 shows the detection of a pothole by means of the headlights of a vehicle;

FIG. 6 shows by means of the headlights of a vehicle that there is no pothole present;

FIG. 7 shows a driving assistance device; and

FIG. 8 shows a method for generating driving assistance.

### DESCRIPTION

The following detailed description refers to the accompanying drawings, which illustrate exemplary details and embodiments in which aspects of this disclosure may be put into practice.

The word “exemplary” is used here in the sense of “serving as an example, instance, or illustration”. Any embodiment or design described herein as “exemplary” is not necessarily to be understood as preferred or advantageous over other embodiments or designs.

Unless otherwise specified, the drawings will designate identical or similar elements, features and structures with the same reference numbers.

The expressions “at least one” and “one or more” can be understood to indicate a numerical quantity greater than or equal to one (for example, one, two, three, four, [ . . . ], etc.). The phrase “at least one of” with reference to a group of elements can be used here to mean at least one element from the group of elements. For example, the phrase “at least one of” can be used here with respect to a group of elements to mean a selection of: one of the listed items, a plurality of one of the listed items, a plurality of individual listed items, or a plurality of multiple individual listed items.

The words “plural” and “multiple” in the description and in the claims explicitly refer to a quantity greater than one. Accordingly, all expressions that explicitly refer to the above words (e.g., “a plurality of [elements]”, “multiple [elements]”) refer to a set of elements, explicitly to more than one of the mentioned elements. For example, the phrase “a plurality” can be understood to indicate a numerical quantity greater than or equal to two (for example, two, three, four, five, [ . . . ], etc.).

The expressions “group (of)”, “set (of)”, “collection (of)”, “series (of)”, “sequence (of)”, “grouping (of)”, etc. in the description and in the claims, if any, refer to a quantity equal to or greater than one, i.e. one or more. The terms “proper subset”, “reduced subset”, and “smaller subset” refer to a subset of a set that is not equal to the set, that is, a subset of a set that contains fewer elements than the set.

The term “data” used here can be understood to mean that it contains information in any appropriate analog or digital form, for example, in the form of a file, part of a file, a set of files, a signal or stream, a part of a signal or stream, a set of signals or streams, and the like. In addition, the term “data” can also be used to refer to information, for example in the form of a pointer. However, the term “data” is not limited to the above-mentioned examples and can take different forms and represent any kind of information as understood by persons skilled in the art.

The terms “processor” or “controller” used here, for example, can be understood as any type of technological unit that allows data to be processed. The data can be processed according to one or more specific functions performed by the processor or control unit. Furthermore, a processor or control unit as used herein can be understood to mean any type of circuit, e.g. any type of analog or digital circuit. A processor or control unit can therefore be or comprise an analog circuit, a digital circuit, a mixed signal circuit, a logic circuit, a processor, a microprocessor, a central processor (CPU), a graphics processing unit (GPU), a digital signal processor (DSP), a Field Programmable Gate Array (FPGA), an integrated circuit, an Application Specific Integrated Circuit (ASIC), etc., or any combination thereof. Any other way of implementing the respective functions, as further described below, can also be understood as a processor, controller or logic circuit. It is understood that two (or more) of the processors, controllers or logic circuits described herein can be implemented as a single unit with equivalent functionality or similar; and that, conversely, a single processor, controller or logic circuit described herein can be realized as two (or more) separate units with equivalent functionality or similar.

The term “memory” here refers to a computer-readable medium (e.g. a non-transitory computer-readable medium) in which data or information can be stored for retrieval. When “memory” is mentioned here, it can mean a transitory or non-transitory memory, including a direct access memory (RAM), a fixed-value memory (ROM), a flash memory, a solid-state memory, a magnetic tape, a hard disk drive, optical drive, a 3D XPointTM, or any combination thereof. Registers, shift registers, processor registers, data buffers, etc. are also grouped here under the term memory. The term “software” refers to all types of executable commands, including firmware.

Unless explicitly stated, the term “transmission” includes both direct (point-to-point) and indirect transmission (via one or more intermediate points). Similarly, the term “receive” includes both direct and indirect reception. In addition, the terms “send”, “receive”, “communicate” and similar terms include both physical transmission (e.g., transmission of radio signals) and logical transmission (e.g., transmission of digital data over a software-level logical connection). For example, a processor or control unit may send or receive data over a software-level connection to another processor or control unit in the form of radio signals, wherein the physical transmission and reception are handled by radio-layer components such as the RF transceiver and antennas, and the logical transmission and reception is carried out via the software-level connection by the processors or control units. The term “communicate” refers to both sending and receiving, i.e. unidirectional or bidirectional communication in one or both directions, i.e. incoming and outgoing. The term “calculate” includes both “direct” calculations using a mathematical expression/formula/relationship, as well as “indirect” calculations using look-up or hash tables and other array indexing or search operations.

In the following, the term “image sensor” is used for both a camera sensor and a LIDAR (Light Detection and Ranging) sensor. The image sensor can be configured to generate image data that can be in a standard image format (such as .jpg, .gif, .tiff, .bmp, .dng, etc.) or in a point cloud format. If a “sensor” is specified for the acquisition of sensor data about the vicinity of a vehicle, the sensor may be or comprise a camera sensor or a LIDAR sensor. If a camera sensor is used, the person skilled in the art will understand that a plurality of camera sensors can be used, and then a photogrammetry technique or multiple photogrammetry techniques can be used to generate 3D or depth information for use in object/obstacle detection and mapping.

Various aspects of this disclosure describe the detection and navigation of a vehicle when faced with a bumpy (e.g., uneven) road surface and/or a road surface with multiple potholes and unpaved, navigable terrain. To simplify this description and to avoid unnecessary repetition, the detected uneven sections, potholes and/or uneven road or off-road surfaces are simply referred to here as “irregularities of a road surface”.

As described above, conventional driving assistance systems are designed to detect individual objects or obstacles, and such systems may sometimes be insufficient for meeting the requirements of poor road conditions such as gravel or unpaved roads, or of otherwise bumpy roads or roads with significant potholes. The detection and warning of a single pothole or hump may be insufficient to provide meaningful instructions for driving a vehicle over a generally bumpy road or a road with many potholes. Instead, a meaningful driving instruction is required that informs the driver, for example, that a lane change or another route is better or even optimal, or that a certain pothole should not be driven over at more than 10 km/h, or that a certain suspension setting should be set. To achieve this objective, an approach is described in the following, in which the system generates a risk map from which driving instructions are derived. The risks shown in the risk map should not remain static, but may vary depending on the vehicle, load, weather conditions, time of day, etc.

For reasons of clarity, the term “driving instruction” in relation to a vehicle operated by a human driver can be understood as a recommendation for a driving action that the human driver is able to take. This means that the driving assistance system can recommend a specific procedure (e.g. slowing down, changing lanes, etc.) and the human driver can choose to implement this procedure or not. In connection with autonomous or semi-autonomous vehicles (e.g. L3+), the instruction is an action instruction that is sent by the driving assistance device to the autonomous driving system, which can then decide whether or how to implement the instruction.

An assistance system for poor-quality roads can give a human driver meaningful driving instructions to reduce the risk of damage to the vehicle due to humps and/or potholes. Such risks may include, but are not limited to, punctures, mechanical failure, damage to the vehicle or loss of control of the vehicle. Alternatively or in addition, the driving instructions may improve driving comfort by reducing the forces acting on the human driver and/or occupants as a result of driving over bumpy roads and/or potholes, e.g. by reducing the vehicle speed when driving over these irregularities, by selecting road surface irregularities which are to be driven over with the least impact on the vehicle and/or the driver or its occupants, or by taking a suitable course or by completely avoiding road surface irregularities.

The driving assistance device can use one or more cameras or LIDAR sensors or radar sensors to acquire road surface data by detecting potholes or irregularities and creating a list of these detected potholes or irregularities for further processing. The driving assistance device can then use this detected road surface data to generate instructions (e.g., instructions for a driver and/or driving instructions), such as speed and travel path. Such instructions can be derived from a risk analysis or simulation. These instructions can be optionally displayed, for example on the vehicle dashboard or in a head-up display (HUD). If the vehicle is operated with an L3(+) system (e.g. a system that reaches or exceeds an L3 level of autonomous functions according to the international SAE classification), the instruction can also be used as an input to the driving strategy for autonomous driving.

The driving assistance device disclosed herein is able to provide meaningful driving instructions to a human driver or an autonomous driving system to reduce the risk of tire punctures, mechanical failures, loss of control, or similar, and/or improve driving comfortability on uneven roads full of humps and potholes. The system can use the results of existing methods for detecting humps and potholes to create a risk map of the driving area. The system may create the risk map using road surface data that correspond to the identified irregularities of a road surface and the data referred to herein as vehicle data, which include, but are not limited to, vehicle speed, vehicle load, type or distribution of the vehicle load, ground clearance, suspension, number and position of axles/wheels, center of gravity or the condition or composition of the road surface or the terrain. On the basis of this risk map and optionally with other information from ADAS systems or sensors, the driving assistance device can calculate a travel path (trajectory) and/or an optimal speed, and/or perform suspension adjustments. This can then be provided to the driver. In some cases, the information can be displayed to the driver as a camera image overlay (or similar), in a HUD, or in or on the dashboard. Alternatively or in addition, this driving assistance device can also be used for L3+ vehicles to change their planned trajectory in self-driving mode.

As will be described in more detail, the driving assistance device may also contain multiple extensions to adjust the suspension and/or tire pressure and to integrate further sensor data (or ADAS data), which include, for example, the material or material properties of a surface (e.g. asphalt, gravel, sand, field, vegetation, puddles, etc.; strength, flexibility, sinking behavior, etc.), for example, to manage situations with soft sand or to observe how a vehicle traveling ahead or observed elsewhere responds to an irregularity in the road. In addition, data from systems that monitor drivers and passengers and provide personal data (e.g. discomfort, sleep, frailty, etc.) can be included in the determination of a driving instruction.

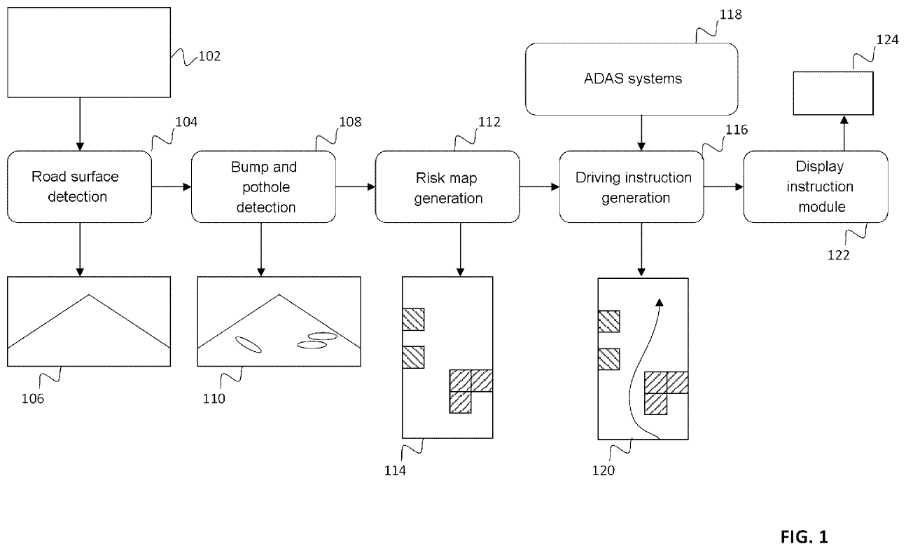

FIG. 1 shows elements of the driving assistance device. Firstly, the driving assistance device must detect irregularities and/or potholes in the road surface and the corresponding data from this detection are generally referred to here as road surface data. To do this, the vehicle must either have access to information about the irregularities of the road surface (e.g. in a database), or the vehicle is able to detect the road surface irregularities. When accessing information about road surface irregularities, such as in a database, the vehicle can access a database or list of irregularities of a road surface (such as humps/potholes), e.g. with dimensions and locations. Although such a list can be configured in different ways depending on the implementation, a sample format may look like this:

| | Location (e.g. in vehicle | |
|---|---|---|
| Type | coordinates) | Dimensions |
| Fender | x = 5 m, y = 0 m, z = 0 m | x = 0.2 m, y = 6 m, z = 0.4 m |
| | (i.e. the hump is 5 m in | (i.e. the hump is 40 cm |
| | front of the vehicle) | high and 6 m wide) |
| Pothole | x = 10 m, y = −1 m, z = 0 m | x = 0.2 m, y = 0.2 m, |
| | (i.e. the hump is 105 m in | z = −0.05 m (i.e. the |
| | front of the vehicle | pothole is 5 cm deep) |
| | and 1 meter to the right) | |
| Pothole | x = 8 m, y = 3 m, z = 0 m | x = 0.4 m, y = 0.4 m, |
| | (i.e. fender 8 m in front | z = −0.4 m (i.e. a large |
| | of the vehicle and 3 m to the | pothole with a depth of 40 cm) |
| | left, e.g. on the opposite lane) | |

Such information may be present, for example, in one or more cloud-based mapping services, which means that not every vehicle needs to be equipped with sensors or systems for detecting humps/potholes. Thus, the vehicle may contain a transceiver that may be configured to receive a wireless signal representing the above-mentioned road surface data. The vehicle (one or more processors in the vehicle) may be configured to control the transceiver to establish a wireless connection to a service (such as a database service and a mapping service) and to retrieve road surface data, such as information related to the location of the vehicle or the expected location of the vehicle. This list of road surface irregularities can then be used to generate meaningful driving directions, as described in more detail below.

FIG. 1 shows a configuration in which the vehicle detects information about road surface irregularities on the basis of sensor data (e.g. image sensor data and/or LIDAR data). In this figure, the vehicle uses its own sensors (e.g. cameras, LIDAR, etc.) to generate sensor data 102 about a road surface in the vicinity of the vehicle or otherwise has access to raw sensor data (e.g. via a transceiver or stored information). The steps for detecting road surface irregularities from this sensor data are described below. First, the driving assistance device can be configured to carry out a road surface detection 104, in which the sensor data are analyzed to demarcate a road surface from a non-road surface. The result of such an analysis may include the sensor data in which the road surface is highlighted, marked or otherwise demarcated, as shown in 106.

Following the detection of the road surface 104, the driving assistance device can carry out a detection of road surface irregularities (pothole detection) 108, in which the demarcated road surface is examined for road surface irregularities (see resulting image 110). This can be carried out using any conventional sensor data analysis method that is capable of isolating a feature (in this case the road) within the sensor data. Alternatively or additionally, the driving assistance device can include an artificial neural network that may be configured to receive image sensor data indicating a detected road surface, and to detect the irregularities of the road surface (e.g. uneven sections and/or potholes) in this sensor data. Regardless of the method, the result of the detection 108 can reproduce data (e.g. the sensor data or data corresponding to the sensor data), in which irregularities of the road surface are marked, delimited, highlighted or otherwise identified 110. Alternatively or in addition, the pothole detection 108 can display a list of identified road surface irregularities. This list can include any type of irregularities of a road surface, locations of road surface irregularities, or dimensions of road surface irregularities.

The driving assistance device can then proceed with the generation of a risk map 112. For this step, the driving assistance device can receive the output of the hump/pothole detection 108 (e.g. the list of road surface irregularities). However, this input alone may not always be sufficient to estimate the risk of loss of comfortability or control, a collision, tire damage, a mechanical failure, or similar. Therefore, the risk map generator 112 may be configured to combine the information about road surface irregularities with vehicle data, which, as mentioned above, may contain information from one or more additional sources. Vehicle data may include, for example, tire pressure, information on the suspension (e.g. accelerometers), vehicle load and load distribution information, or belong to sensors in the vehicle cabin that observe/monitor passengers' comfortability. As an alternative or in addition, the vehicle data may also contain passenger comfort data that can represent the comfortability of a passenger in the vehicle. Alternatively or in addition, the vehicle data can also contain the current speed of the vehicle. In addition, information on road friction, such as information from sensors of the anti-lock braking system (ABS)/electronic stability program (ESP), can be taken into account to determine whether the vehicle is currently on a loose or soft surface, which may affect the risk assessments.

Based on this data, the risk map generator 112 can determine the risks for each hump, pothole or any other irregularity of the road surface. If the road surface is discretized in the form of a grid, the risks can be estimated for each grid cell. In this context, it should be noted that different approaches can be used for the risk assessment at run time (i.e. while the vehicle is driving on the bumpy road). It is possible to use learning-based solutions such as artificial intelligence (e.g. an artificial neural network), which can use, for example, a color image from a bird's eye view as input in order to create a risk map for each aspect, which can then be accumulated into a single risk map. Alternatively or in addition, one or more predefined look-up tables can be used. An example look-up table is shown below:

| | Vehicle | | Speed | Probability of | | Probability of loss |
|---|---|---|---|---|---|---|
| Hump/pothole | weight | | [km/h] | puncture | Comfortability | of control |
| Hump +20 cm | 2 | tons | 5 | Low | High | None |
| Hump +20 cm | 2 | tons | 10 | Low | Ok | None |
| Hump +20 cm | 2 | tons | 15 | Low | Low | Low |
| Hump +20 cm | 2 | tons | 20 | Medium | Very low | Medium |
| Hump +20 cm | 3.5 | tons | 20 | High | Very low | High |
| Pothole −40 cm | 2 | tons | 5 | Low | Low | Low |
| Pothole −40 cm | 2 | tons | 10 | Medium | Very low | Medium |
| Pothole −40 cm | 2 | tons | 15 | Medium | Very low | Medium |
| Pothole −40 cm | 2 | tons | 20 | High | Very low | High |
| Pothole −40 cm | 3.5 | tons | 20 | Very high | Very low | Very high |

This table shows the irregularity of the road surface in the category “humps/potholes”. The vehicle data are given as “vehicle weight” and “speed”. Of course, other or additional vehicle data can also be taken into account, as indicated here. On this basis, the risk of a puncture (“probability of a puncture”), the estimated level of comfort for a human driver or front passenger (“comfortability”) and the risk of loss of control (“probability of loss of control”) are calculated. Based on these findings, the system can generate one or more driving instructions.

In an alternative configuration, this online system can be combined with an offline system, which can be configured to take into account both recorded data and simulation data in order to associate the comfortability, the probability of mechanical failures, etc. with different speeds and road surface irregularities. Such an offline system can be used to train the learning-based approach or to populate/update the look-up table.

A look-up table or a learning-based approach can provide (online) a baseline for each risk level that can then be adjusted, for example with an offset, using the current sensor data in the cabin. For example, human comfortability (such as the comfortability of a driver or front passenger) varies from person to person, as each person reacts differently to irregularities in the road surface. Therefore, the results of the risk assessment can be adjusted by observing the current comfort level. If, for example, the systems in the cabin detect a strong head shaking (e.g. due to road humps), but the risk assessment system reports a presumed high level of comfortability, the high level of comfortability can be adjusted to a lower level accordingly. This offset can be dynamically adjusted based on the incoming/available sensor data.

The system can optionally be configured not only to evaluate irregularities/potholes in isolation, but also to detect patterns or repetitions (e.g. an undulating pattern that can develop spontaneously, such as on an unpaved road). On roads with such an undulating pattern, or on roads with many closely spaced road surface irregularities, an isolated analysis can lead to sub-optimal results. Therefore, a combined analysis is provided to determine the best response, such as the best speed in the light of the current tire pressure, vehicle weight and the undulation profile.

It is also pointed out that human drivers or front passengers may have different interests to those that promote or extend mechanical stability. For example, it may feel better for a human occupant to drive faster rather than slower on such “wavy” roads, but a lower speed would be better for the mechanical components and tires. Taking into account this fact, the driving assistance device can attempt to determine the best compromise between these competing aspects, or the driving assistance device can weight these competing interests on the basis of one or more predetermined preferences (e.g. always preferring mechanical integrity to comfort, etc.). In this way, the risk map generator 112 can create one or more risk maps that can associate risks to each hump/pothole, or alternatively on a grid basis as shown in 114. That is, the risk map can be a data visualization tool in which individual road surface irregularities are identified relative to the vehicle or relative to one or more reference points (e.g. relative to the vehicle, in Cartesian space, etc.), and each of the road surface irregularities can be assigned a risk. Alternatively, the risk map may be divided into sectors, so that a sector corresponding to one or more road surface irregularities is associated with a certain risk (e.g. corresponding to a single road surface irregularity or corresponding to multiple road surface irregularities). The risk map may contain a discretized grid, which in turn has a plurality of cells. In this way, each cell of the plurality of cells can correspond to a discrete area of the road surface and to a risk associated with driving the vehicle over this discrete area of the road surface.

Using the risk data from the preceding module, the driving assistance device can then generate driving instructions 116 on the basis of the risk map generated by the risk map generator 112. In this way, the driving assistance device can calculate a feasible travel path with any speed profile, any suspension setting (e.g. harder, softer, higher or lower driving height) or the recommended mode (e.g. 2-wheel drive or 4-wheel drive, if available).

For this purpose, the driving assistance device can be used to implement a plurality of planners (e.g. trajectory planner). For example, the driving assistance device may contain or use a particle filter with positive weighting for low-risk regions and negative weighting for high-risk regions. Each particle can then represent a next step along a path, so the result of the filtering process is a near-optimal travel path including speed instructions.

In this context, the planner can be allowed to use the entire driving surface, including the driving lanes for oncoming traffic, without needing to protect itself against it. In order to prevent the planner from giving an instruction that brings the driver into collision or near collision with other road users, the driving assistance device can receive data from other ADAS systems 118. In this way, the driving instruction generator 116 can take into account environmental information perceived by other road users during the route planning. In the absence of oncoming traffic, the driving instruction generator 116 can thus generate an instruction in which the driver or the vehicle is instructed to drive in an adjacent lane (e.g. for oncoming traffic). Alternatively, the driving instruction generator 116 can instruct the vehicle or the driver to stay on the lane where oncoming traffic has right of way. In this case, the travel instruction generator 116 can give an alternative instruction, e.g. to reduce speed in order to maintain an acceptable risk level. An instruction of the driving instruction generator 116 is shown for illustration purposes in 120, in which a travel path around identified risk areas (corresponding to the irregularities of the road surface) is shown.

Although the risk map generator 112 and the driving instruction generator 116 are shown as separate units, it is explicitly noted that they can be combined in a single unit and/or a single processor. In an alternative configuration, each of these units can be combined into a single artificial intelligence system (such as an artificial neural network), which can be trained to perform both the risk assessment as well as generating the driving instructions. Alternatively or in addition, the driving instruction generator 116 can be combined with one or more decision modules to assess, for example, whether the tire pressure needs to be adjusted (decreased or increased).

Once the driving instruction has been created, the display instruction module 122 transmits this information to the driver, if present. In this way, the display instruction module 122 can use the generated instructions for travel path, speed or other parameter of the previous module or modules to interact with the driver. This can happen in different ways.

The simplest way is to display only one speed instruction in the dashboard/HUD 124 of the vehicle. By this method, a visual representation of the speed instruction can be displayed. This can be a number (e.g. “recommended speed: 40 km/h”), a representation of a speedometer, a representation of deceleration, or something else.

Alternatively or in addition, the display instruction module 122 can overlay the determined path onto a camera image to create a better visual context for the best route. This can be communicated to the driver in a road visualization or map format that shows a preferred travel path. Alternatively or in addition, this can be communicated to the driver in the form of an instruction, e.g. “Turn left”, “Change lane”, “Turn left two meters”, etc.

Alternatively or in addition, the display instruction module 122 can give the driver instructions on the tire pressure. In many vehicles, the tire pressure can only be changed manually, so that the driver can be instructed to increase or decrease the tire pressure in order to reduce the loading on the vehicle and/or to improve the driver's comfortability. However, in some vehicles, the tire pressure can be adjustable automatically or semi-automatically, so that the tire pressure can be adjusted on the basis of an instruction, e.g. an instruction in an autonomous driving system, or on the basis of a driver's approval or instruction.

In addition to the normal driving instructions, the driving assistance device can optionally include a rescue instruction mode. Such a rescue instruction can become active if the driver has already steered into an area that corresponds to a road surface irregularity. Instead of a recommended lane, the system can then give rescue instructions such as “slow down”, “keep right” or similar, allowing the driver to negotiate the high-risk area. Depending on the driver's profile and the capabilities of the vehicle assistance systems, an active intervention (e.g. adding a torque to the steering wheel in a certain direction) may also be possible. If the vehicle comes to a standstill in an area corresponding to a road surface irregularity, more detailed rescue recommendations can be computed (e.g. “Activate the all-wheel drive and drive slowly straight ahead”).

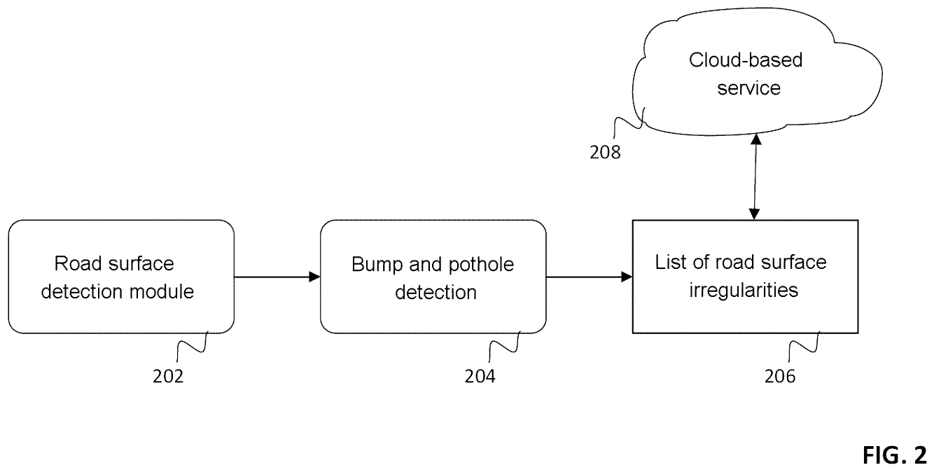

FIG. 2 shows an alternative implementation of the modules 104 and 108 from FIG. 1, in which the irregularities of the road surface are identified for the subsequent generation of a risk map and driving instructions. In this figure, the road surface detection module 202 detects the road surface as described in 104, and the hump and pothole detection module 204 detects the road surface irregularities as described in 108. However, as shown here, the output of these modules is a list of road surface irregularities (e.g., humps/potholes) 206, which serves as the basis for subsequent driving instructions. In a first option, the module 204 can be configured to detect humps and potholes to display the list of the road surface irregularities 206. In an alternative configuration, the list of road surface irregularities 206 can be obtained from one or more cloud-based services 208. In this way, the vehicle can send a request to the cloud-based service 208 with a current position of the vehicle (e.g. a GPS position, a position relative to another reference point, etc.). In response, the cloud-based service 208 can provide a map of the surrounding areas together with information on road surface irregularities, from which the module 204 for detecting irregularities and potholes can derive the list of road surface irregularities 206. Alternatively, the cloud-based service 208 can transfer the list of road surface irregularities 206 directly to the vehicle. In this way, the list of road surface irregularities 206 can contain coordinates with respect to a reference point, e.g. the notified location of the vehicle, et cetera.

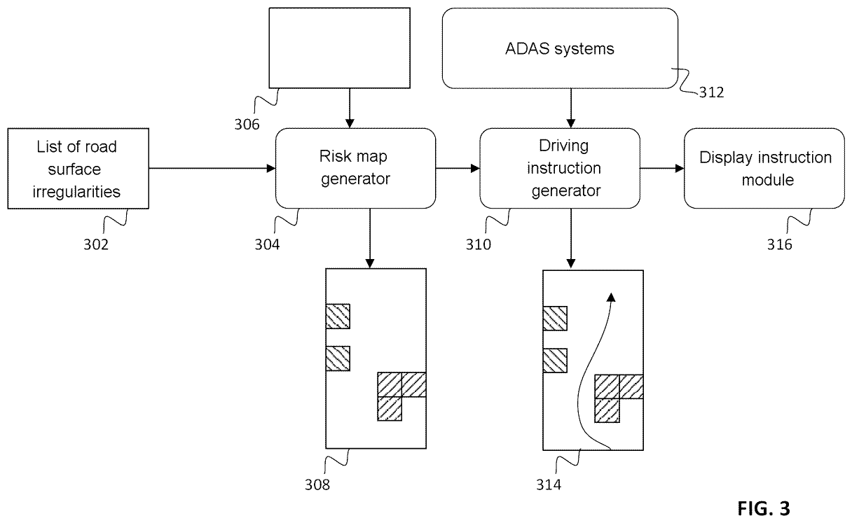

FIG. 3 shows the elements shown in FIG. 1 as 112 to 122 in greater detail. In this way, the driving assistance device receives the list of road surface irregularities 302 and creates from the list of road surface irregularities 302 a risk map 304 together with additional information, as illustrated generally in FIG. 306, wherein the additional information may include tire pressure sensors, suspension sensors (e.g. accelerometers), information on the vehicle load and/or load distribution, interior sensors for monitoring or monitoring the comfort of passengers, the current vehicle speed, information on road friction or information on road surface quality. Such information may also be otherwise available in the vehicle, and the driving assistance device may be configured to receive these other measurements or data and include them in the calculation of the risk map.

As shown at least in 308, the risk map may represent one or more risks associated with an irregularity of the road surface. In this context, it is useful to distinguish the present disclosure from a conventional device configured to identify a single obstruction or damaged area on the road surface. Such conventional devices are poorly suited to detecting risks within a poor-quality road surface in which the entire road surface may be uneven or damaged, or in which the damaged areas are close together. In such areas, it can be assumed that a major part or even the entire road surface represents a risk, for example an above-average risk. In such cases, the driving assistance device can identify relative risk levels associated with the road surface irregularities, so that areas can be identified that correspond to multiple different risk levels (e.g., at least 2 risk levels, at least 5 risk levels or at least 10 risk levels, etc.). In this way, it is possible to identify a path on which the least risk occurs. Such risk maps can be divided into sectors, so that the vicinity of the vehicle is divided into a plurality of sectors, and each sector is assigned a risk corresponding to the quality of the road surface when considered in the light of the additional information described above.

Based on the risk map, the driving instruction generator 310 generates one or more driving instructions which present the least risk. This can primarily include the specification of a travel path (see 314) and/or a driving speed. For example, a driver can be instructed to continue on the current travel path, change the travel path according to an instruction, or to increase or decrease their speed.

It should be noted that the driving instruction generator 310 can optionally generate its driving instructions on the basis of the risk map and one or more ADAS systems 312. In this way, the output of other ADAS systems, such as a perception system, can be taken into account when selecting a travel path to avoid routes that could otherwise expose the vehicle to increased risk, for example by turning into the path of another vehicle.

The display instruction module 316 can then convert the instruction into a notification for the driver. Such a notification can be a visual notification, which is displayed, for example, on a HUD, dashboard, or similar. Alternatively or in addition, the driving instruction may be or include an audio instruction and/or a haptic instruction.

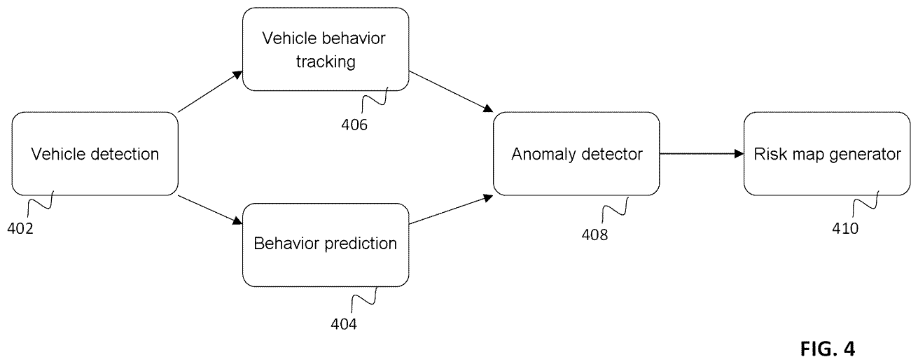

In addition to detecting road surface irregularities using sensor data, the driving assistance device can optionally be configured to detect road surface irregularities by analyzing the behavior of another vehicle driving ahead, as shown in FIG. 4. In this way, the driving assistance device can recognize relevant attributes of the behavior of another vehicle (a vehicle driving ahead) to model and predict a road surface irregularity and/or the future driving behavior of the vehicle on the basis of the actions of the other vehicle. In an optional configuration, speed and direction of travel can be used to determine the road surface. In other optional configurations, one or more behavior models can be used for specific vehicle classes (e.g. motorcycle, truck, car) or specific vehicle types (e.g. pickup, SUV).

By tracking the vehicle and comparing it to a predicted behavior, anomalies in driving behavior can be detected. Since these anomalies can correspond to road surface irregularities, information on road surface irregularities can be obtained from these observations. Examples of such anomalies include a vehicle that is leaning to one side (e.g. due to a pothole), a jolting behavior (e.g. due to a hump), or a vehicle that is sliding sideways (e.g. due to sand). The location of these anomalies is calculated and a risk map is created for further processing.

FIG. 4 shows a device for detecting anomalies of the road surface on the basis of the vehicle behavior tracking. This device can be configured to detect a vehicle 402, e.g. using sensor data (e.g. camera data or LIDAR data). This can be carried out using known techniques, such as techniques for vehicle or object detection with image sensor data, or by modifying the modules for road detection and/or road surface irregularity detection, as described above, to identify vehicles.

The unit can be configured to predict the behavior of an identified vehicle 404. For example, it is predicted that a vehicle that exhibits smooth operation will also maintain it; for a vehicle that is driving straight ahead it is predicted that it will continue to drive straight ahead; a vehicle that is driving in a level configuration (for example, without leaning sideways) is predicted to continue driving in a level configuration. The unit can be configured to predict any type of future behavior and compare it to the observed behavior, without limitation and irrespective of the above examples.

The vehicle behavior is tracked 406 or observed, and this observed behavior 406 is compared to the predicted behavior in 404. If the driving behavior matches the predicted behavior, no anomaly is detected. However, if the road behavior deviates from the predicted behavior, the resulting deviation can be attributed to a road anomaly. In this way, the anomaly detector 408 can determine a road anomaly from the difference between the road behavior 406 and the predicted behavior 404. For example, a vehicle that is predicted to drive smoothly but suddenly shows a bumpy motion may indicate a hump or a sleeping policeman, and such an irregularity in the road surface can be attributed to the location where the deviant behavior occurred. Similarly, a vehicle that is predicted to drive smoothly but suddenly leans to the left may indicate a pothole or other irregularity of the road, in particular in the area of the tires on the left.

Based on the findings made by the anomaly detector 408, the unit can create the risk map 410 for use as described above. In addition, or alternatively, the unit can update a previously generated risk map 410 to include road surface irregularities that might otherwise not have been detected based on the visualization of the road surface itself.

By predicting and comparing the vehicle's own behavior, road surface irregularities can be detected and stored in a risk map. A locally stored risk map can be generated together with the location. Whenever the vehicle drives on the same road again, the risk map can be reused to improve the risk calculation. This risk map can then also be used when generating a route (for example, select the route with the fewest potholes).

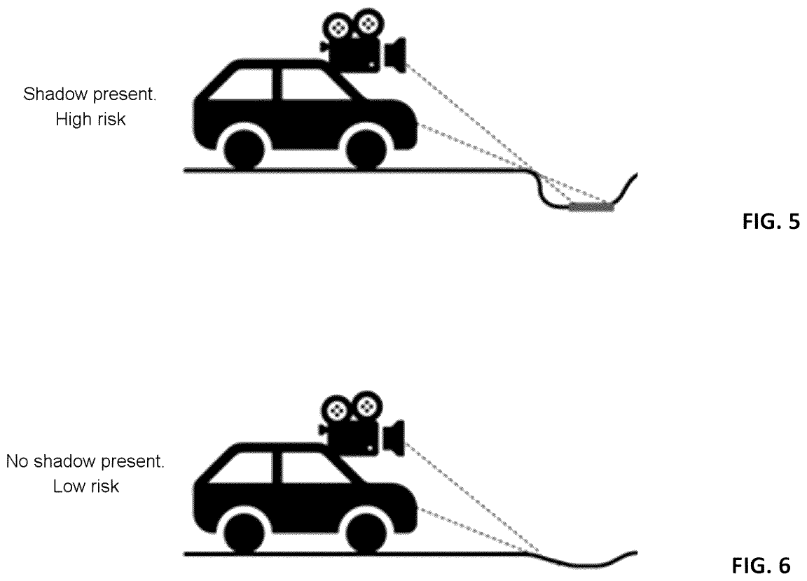

FIGS. 5 and 6 show the detection of irregularities on the road surface by light illumination. Potholes can cause unnecessary mechanical stress on a vehicle, which can cause or contribute to vehicle damage. In particular at night, it can be difficult to detect a pothole, as it is particularly difficult for the human eye to see. Therefore, the vehicle can optionally be configured to calculate the risk due to a pothole based on the shadow of the pothole cast by the headlights of the vehicle. The underlying principle is that the headlights of a vehicle that shine across a pothole create a shadow within the pothole that is obscured by the edge of the pothole. This is shown in FIG. 5, in which the headlights of the vehicle illuminate the edge of the pothole, creating an area of shadow within the pothole. The image sensor captures an image of the pothole in the shaded area, and the unit detects a pothole from the shadow. Typically, a larger shadow means a deeper pothole and a smaller shadow means a shallower pothole. In comparison between FIGS. 5 and 6, FIG. 6 shows a comparatively small irregularity in which the light falling on the edge of the irregularity does not produce a shadow (e.g. due to the angle of incidence of the light from the headlight on the edge of the irregularity). The absence of a shadow indicates either that there is no pothole or that it is a comparatively small pothole or a comparatively small irregularity.

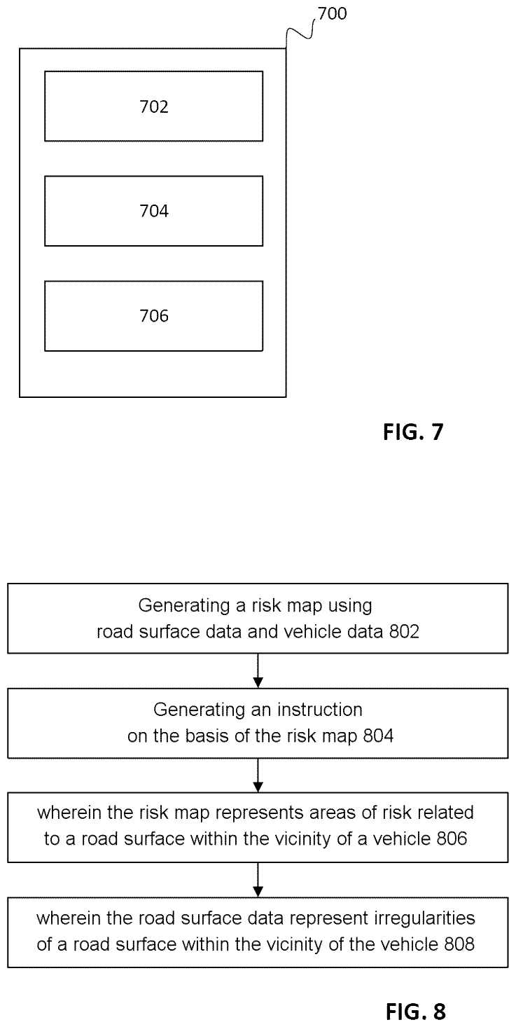

FIG. 7 shows a driving assistance device 700 containing a processor 702 configured to generate a risk map using road surface data and vehicle data and to generate an instruction on the basis of the risk map, wherein the risk map represents areas of risk related to a road surface within a vicinity of a vehicle; and wherein the road surface data represent irregularities of a road surface within the vicinity of the vehicle. The driving assistance device 700 may further comprise a sensor 704 configured to receive data representing the vicinity of the vehicle; wherein the processor 702 is further configured to identify the road surface irregularities on the basis of the data. The driving assistance device 700 may further comprise a transceiver 706 which is configured to receive a wireless signal representing the road surface data.

FIG. 8 shows a method for generating driving assistance 800, including generating a risk map using road surface data and vehicle data 802; and generating an instruction on the basis of the risk map 804; wherein the risk map represents areas of risk related to a road surface within a vicinity of a vehicle 806; and wherein the road surface data represent irregularities of a road surface within the vicinity of the vehicle 808.

At various points, the observation of a driver or one or more passengers in the cabin, e.g. by means of image sensors, has been indicated. This can be done with any existing image sensor that is configured to acquire image data of the cabin interior, or with one or more additional image sensors specifically designed for this task. One or more processors may be configured to receive the corresponding image sensor data and perform one or more analyses of the data to identify a driver and/or passenger and to make one or more observations on a comfortability level of the driver and/or the passenger. Such comfortability level determinations can be made by observing body movements, so that sudden, bouncing, or rapid swinging movements can be associated with discomfort, while stationary bodies or bodies with only minor movements can be associated with comfort. Alternatively, or in addition, the processor may be configured to isolate and determine one or more facial expressions in the image sensor data so that comfortability or discomfort can be derived from these facial expressions (e.g., smiling or neutral facial expressions may be associated with comfort, while frowning, expressions associated with disgust, expressions associated with nausea, etc. can be associated with discomfort). This allows the processor to be configured to adjust the risk levels in the risk map dynamically on the basis of passenger comfort data.

As mentioned here, the processor may be configured to carry out any of the determination steps described here by using direct calculations or by using one or more artificial neural networks. Such artificial neural networks can be configured to receive the road surface data and the vehicle data and to output the risk map.

The conversion of an identified irregularity of the road surface together with vehicle data into a risk can be carried out according to another configuration by using a look-up table. In this way, the look-up table can contain risk magnitudes that correspond to the irregularities of a road surface and the vehicle data. This allows the processor to be configured to generate the risk map by looking up a road surface irregularity and corresponding vehicle data and then using the look-up table to determine the resulting risk.

Further aspects of the disclosure are described using examples.

In example 1 a driving assistance device containing a processor is configured to generate a risk map using road surface data and vehicle data; and to generate an instruction on the basis of the risk map; wherein the risk map represents areas of risk related to a road surface within a vicinity of a vehicle; and wherein the road surface data represent irregularities of a road surface within the vicinity of the vehicle.

In example 2, the driving assistance device according to example 1 contains an image sensor configured to receive data representing the vicinity of the vehicle; wherein the processor is further configured to generate the road surface data by identifying road surface irregularities on the basis of the data.

In example 3, the driving assistance device according to example 1 also contains a transceiver configured to receive a wireless signal representing the road surface data.

Example 4 is the driving assistance device according to any one of examples 1 to 3, wherein the risk map comprises a discretized grid comprising a plurality of cells, and wherein each cell of the plurality of cells corresponds to a discrete area of the road surface and a risk associated with travel of the vehicle over the discrete area of the road surface.

Example 5: The driving assistance device according to any one of examples 1 to 4, wherein the vehicle data comprise a tire pressure, suspension sensor data, accelerometer data, vehicle load data, or vehicle load distribution data.

Example 6: the driving assistance device according to any one of examples 1 to 5, wherein the vehicle data contain data on passenger comfort, which represent the comfortability of a passenger in the vehicle.

Example 7 shows the driving assistance device according to example 6, further comprising an image sensor in the cabin, which is configured to generate a signal that represents an image of the passenger in the vehicle; wherein the processor is further configured to determine the passenger's comfortability in the vehicle from the signal.

Example 8 is the driving assistance device according to example 6 or 7, wherein the processor is configured to dynamically adjust the risk levels in the risk map based on the passenger comfort data.

In example 9, the driving assistance device according to any one of examples 1 to 8 further contains an artificial neural network configured to receive the road surface data and the vehicle data and to output the risk map; wherein the processor that generates the risk map contains the processor that generates the risk map using the artificial neural network.

In example 10, the driving assistance device according to any one of examples 1 to 8 further contains a look-up table with risk magnitudes that correspond to irregularities of a road surface and vehicle data; wherein the processor that generates the risk map contains the processor that generates the risk map using the look-up table.

Example 11: the driving assistance device according to any one of examples 1 to 10, wherein the instruction contains a driving instruction and wherein the driving instruction contains a driving path or a driving speed.

Example 12: the driving assistance device according to any one of examples 1 to 11, wherein the instruction contains an instruction to change a suspension setting.

Example 13: the driving assistance device according to any one of examples 1 to 12, wherein the instruction includes an instruction to switch between a two-wheel drive mode and a four-wheel drive mode.

Example 14: the driving assistance device according to any one of examples 1 to 13, in which the processor is also configured to output the instruction on a vehicle display.

Example 15: the driving assistance device according to any one of examples 1 to 14, wherein the processor is further configured to cause an autonomous driving system to operate the vehicle according to the instruction.

Example 16 is the driving assistance device according to any one of examples 1 to 15, wherein the processor is further configured to determine one or more patterns within the road surface data; wherein generating the driving instruction based on the risk map comprises generating the driving instruction based on the one or more determined patterns.

Example 17 is the driving assistance device according to any one of examples 2 to 16, wherein the vehicle is a first vehicle; and wherein the processor is further configured to: detect a second vehicle in the data of the vicinity of the first vehicle; and to generate road surface data based on a movement of the detected second vehicle.

Example 18 is the driving assistance device according to any one of examples 2 to 17, wherein the processor is further configured to: detect in the data of the vicinity of the vehicle a shadow cast by a headlight of the vehicle shining onto an irregularity of the road surface; generate road surface data based on the detected shadow.

Example 19 is a method for generating driving assistance, comprising: generating a risk map using road surface data and vehicle data; and generating an instruction on the basis of the risk map; wherein the risk map represents areas of risk related to a road surface within a vicinity of a vehicle; and wherein the road surface data represent irregularities of a road surface within the vicinity of the vehicle.

In example 20, the method for generating the driving assistance according to example 19 comprises: having an image sensor which is configured to receive data that represent the vicinity of the vehicle; further, the method comprises generating the road surface data by identifying road surface irregularities on the basis of the data.

In example 21, the method for generating driving assistance according to example 19 also comprises a transceiver configured to receive a wireless signal representing the road surface data.

In example 22, the driving assistance device according to any one of examples 19 to 21, the risk map comprises a discretized grid comprising a plurality of cells, and each cell of the plurality of cells corresponds to a discrete area of the road surface and a risk associated with travel of the vehicle over the discrete area of the road surface.

Example 23: the method for generating driving assistance according to any one of examples 19 to 22, wherein the vehicle data comprise any of tire pressure, suspension sensor data, accelerometer data, vehicle load data, or vehicle load distribution data.

Example 24: the method for generating driving assistance according to any one of examples 19 to 23, wherein the vehicle data contain data on passenger comfort, which represent the comfortability of a passenger in the vehicle.

In example 25, the method for generating driving assistance according to example 24 further comprises an image sensor in the cabin, which is configured to generate a signal that represents an image of the passenger in the vehicle; the method also comprises determining the passenger's comfortability in the vehicle from the signal.

In example 26, the method for generating the driving assistance according to example 24 or 25 also includes the dynamic adjustment of the risk levels in the risk map based on the passenger comfort data.

In example 27, the method for generating driving assistance according to any one of examples 19 to 26 further contains an artificial neural network configured to receive the road surface data and the vehicle data and to output the risk map; and further comprises generating the risk map using the artificial neural network.

In example 28, the method for generating driving assistance according to any one of examples 19 to 26 further contains a look-up table with risk magnitudes that correspond to irregularities of a road surface and vehicle data; and generating the risk map further comprises the processor generating the risk map using the look-up table.

Example 29: the method for generating driving assistance according to any one of examples 19 to 28, wherein the instruction contains a driving instruction and wherein the driving instruction contains a driving path or a driving speed.

Example 30: the method for generating driving assistance according to any one of examples 19 to 29, wherein the instruction contains an instruction for changing a suspension setting.

Example 31: the method for generating driving assistance according to any one of examples 19 to 30, wherein the instruction includes an instruction to switch between a two-wheel drive mode and a four-wheel drive mode.

In example 32, the method for generating driving assistance according to any one of examples 19 to 31 further comprises causing the instruction to be moved to a vehicle display.

In example 33, the method for generating driving assistance according to any one of examples 19 to 32 further comprises causing an autonomous driving system to operate the vehicle according to the instruction.

In example 34 the method for generating driving assistance according to any one of examples 19 to 33 further comprises determining one or more patterns within the road surface data; wherein generating the driving instruction based on the risk map comprises generating the driving instruction based on the one or more determined patterns.

Example 35 is the method for generating driving assistance according to any one of examples 20 to 34, wherein the vehicle is a first vehicle; and further, detecting a second vehicle in the data of the vicinity of the first vehicle; and generating road surface data based on a movement of the detected second vehicle.

In example 36, the method for generating driving assistance according to any one of examples 20 to 35 further comprises detecting in the data of the vicinity of the vehicle a shadow cast by a headlight of the vehicle shining onto an irregularity of the road surface, and generating road surface data based on the detected shadow.

Example 37 is a non-transitory computer-readable medium containing instructions which, if executed by one or more processors, cause the one or more processors to carry out the steps of one of the examples 19-36.

Although the descriptions above and the associated illustrations show the components as separate elements, persons skilled in the art will appreciate the different ways of combining or integrating discrete elements into a single element. This includes combining two or more circuits into a single circuit, mounting two or more circuits on a common chip or chassis to form an integrated element, executing discrete software components on a common processor core, and so on. Conversely, persons skilled in the art will recognize the possibility of dividing a single element into two or more discrete elements, for example, dividing a single circuit into two or more separate circuits, dividing a chip or chassis into discrete elements that were originally intended for it, dividing a software component into two or more sections and executing them on a separate processor core, and so on.

It is assumed that the implementations of the methods described herein are demonstrative in character and can therefore be implemented in an appropriate device. It is also assumed that implementations of the devices described herein can be implemented as a corresponding method. It therefore goes without saying that a device that corresponds to a method described herein may contain one or more components configured to carry out every aspect of the corresponding method.

All acronyms defined in the above description also apply to all claims contained herein.

1. A driving assistance device, comprising:
a processor, configured to:
generate a risk map using road surface data and vehicle data; and
generate a driving instruction based on the risk map;
wherein the risk map represents areas of risk related to a road surface within a vicinity of a vehicle; and
wherein the road surface data represent irregularities of a road surface within the vicinity of the vehicle.

2. The driving assistance device of claim 1, comprising:
a sensor, configured to obtain data representing the vicinity or vicinity characteristics of the vehicle;
wherein the processor is further configured to generate the road surface data by identifying irregularities of the road surface based on the data.

3. The driving assistance device of claim 1, further comprising a transceiver, configured to receive a wireless signal representing the road surface data.

4. The driving assistance device of claim 1, wherein the risk map comprises a discretized grid comprising a plurality of cells, and wherein each cell of the plurality of cells corresponds to a discrete area of the road surface and a risk associated with travel of the vehicle over the discrete area of the road surface.

5. The driving assistance device of claim 1, wherein the vehicle data comprise any of tire pressure, suspension sensor data, accelerometer data, vehicle load data, vehicle load distribution data, chassis data, or passenger data.

6. The driving assistance device of claim 1, wherein the vehicle data comprise passenger comfort data, representing a comfortability of a passenger in the vehicle;
further comprising an in-cabin sensor, configured to generate a signal representing an condition of the passenger in the vehicle;
wherein the processor is further configured to determine the comfortability of the passenger in the vehicle from the signal.

7. The driving assistance device of claim 1, further comprising an artificial neural network configured to receive the road surface data and the vehicle data and to output the risk map;
wherein the processor generating the risk map comprises the processor generating the risk map using the artificial neural network.

8. The driving assistance device of claim 1, further comprising a look-up table comprising risk magnitudes corresponding to irregularities of a road surface and vehicle data; wherein the processor generating the risk map comprises the processor generating the risk map using the look-up table.

9. The driving assistance device of claim 1, wherein the driving instruction comprises a driving path, a driving speed, an instruction to change a suspension setting, or an instruction to change between a single-axel drive mode, and a multiple-axel drive mode.

10. The driving assistance device of claim 1, wherein the processor is further configured to cause the driving instruction to be displayed on a vehicle display.

11. The driving assistance device of claim 1, wherein the processor is further configured to determine one or more patterns within the road surface data; wherein generating the driving instruction based on the risk map comprises generating the driving instruction based on the determined one or more patterns.

12. The driving assistance device of claim 2, wherein the vehicle is a first vehicle; and wherein the processor is further configured to:
detect a second vehicle in the data of the vicinity of the first vehicle; and
generate road surface data based on a movement of the detected second vehicle.

13. The driving assistance device of claim 2, wherein the processor is further configured to:
detect in the data of the vicinity of the vehicle a shadow cast by a headlight of the vehicle shining onto an irregularity of the road surface;
generate road surface data based on the detected shadow.

14. A method of generating driving assistance comprising:
generating a risk map using road surface data and vehicle data; and
generating an instruction based on the risk map;
wherein the risk map represents areas of risk related to a road surface within a vicinity of a vehicle; and
wherein the road surface data represent irregularities of a road surface within the vicinity of the vehicle.

3. A non-transitory computer readable medium, comprising instructions, which, if executed by one or more processors, cause the one or more processors to:
generate a risk map using road surface data and vehicle data; and
generate an instruction based on the risk map;
wherein the risk map represents areas of risk related to a road surface within a vicinity of a vehicle; and
wherein the road surface data represent irregularities of a road surface within the vicinity of the vehicle.

4. The non-transitory computer readable medium of claim 15, wherein the instructions are further configured to cause the processor to generate road surface data by identifying irregularities of the road surface based on data from a sensor.

17. The non-transitory computer readable medium of claim 15, wherein the risk map comprises a discretized grid comprising a plurality of cells, and wherein each cell of the plurality of cells corresponds to a discrete area of the road surface and a risk associated with travel of the vehicle over the discrete area of the road surface.

18. The non-transitory computer readable medium of claim 15, wherein the vehicle data comprise any of tire pressure, suspension sensor data, accelerometer data, vehicle load data, vehicle load distribution data, chassis data, or passenger data.

19. The non-transitory computer readable medium of claim 15, wherein the vehicle data comprise passenger comfort data, representing a comfortability of a passenger in the vehicle.

20. A vehicle, comprising the driving assistance device of claim 1.
